(19) United States
(12) Patent Application Publication
(10) Pub. No.: US 2021/0231943 A1
(43) Pub. Date: Jul. 29, 2021

(54) POLYMER DIELECTRIC COATINGS USED TO CONSTRUCT LIQUID LENS

(71) Applicant: CORNING INCORPORATED, CORNING, NY (US)

(72) Inventors: Robert Alan Bellman, Ithaca, NY (US); Benjamin Jean-Baptiste Francois Burger, Lyon (FR); Michelle Dawn Fabian, Horseheads, NY (US); Timothy Edward Myers, Painted Post, NY (US)

(21) Appl. No.: 17/056,605

(22) PCT Filed: May 20, 2019
(86) PCT No.: PCT/US2019/033102

§ 371 Date: Nov. 18, 2020

Related U.S. Application Data
(60) Provisional application No. 62/674,866, filed on May 22, 2018.

(51) Int. Cl. G02B 26/00; G02B 3/14; H01B 3/44; B05D 1/00

(52) U.S. Cl. CPC G02B 26/005; G02B 3/14; B05D 2506/15; B05D 1/60; H01B 3/445

(57) ABSTRACT

An electrowetting optical device is provided. The electrowetting optical device includes a first window, a second window, and a cavity disposed between the first window and the second window. The electrowetting optical device additionally includes a first liquid and a second liquid disposed within the cavity, the first liquid and the second liquid substantially immiscible with each other and having different refractive indices such that an interface between the first liquid and the second liquid defines a variable lens. The electrowetting optical device also includes a common electrode in electrical connection with the first liquid and a driving electrode disposed on a sidewall of the cavity and insulated from the first liquid and the second liquid by an insulating polymer dielectric layer. The insulating polymer dielectric layer may be formed using initiated chemical vapor deposition (iCVD).

### CROSS-REFERENCE TO RELATED APPLICATIONS

This application claims the benefit of priority under 35 U.S.C. § 119 of U.S. Provisional Application No. 62/674,866, filed May 22, 2018, the content of which is incorporated herein by reference in its entirety.

### FIELD OF THE DISCLOSURE

The disclosure relates to improved polymer dielectric coatings for use in electrowetting optical devices and, more particularly, polymer dielectric coatings that function as both hydrophobic and dielectric layers in a liquid lens.

### BACKGROUND

Conventional electrowetting based liquid lenses are based on two immiscible liquids disposed within a chamber, namely an oil and a conductive phase, the latter being water based. The two liquid phases typically form a triple interface on an isolating substrate comprising a dielectric material. Varying an electric field applied to the liquids can vary the wettability of one of the liquids relative to walls of the chamber, which has the effect of varying the shape of a meniscus formed between the two liquids. Further, in various applications, changes to the shape of the meniscus result in changes to the focal length of the lens.

Conventional liquid lens configurations make use of an insulating feature that resides between an electrode and the immiscible liquids. Polymeric materials are commonly employed as the insulation feature, as they can provide electrical insulation and exhibit a desired hydrophobicity with regard to the wetting properties of one of the liquids. Electrowetting is a phenomenon in which the properties of both the insulating and the hydrophobic layers enable the corresponding wetting effects. Considerable research has been aimed at optimizing the properties of these polymeric layers in order to minimize the voltage required for water contact angle reduction and contact angle hysteresis. At the same time, the materials used should be chemically inert and stable in order to ensure reproducibility and a long lifetime.

Accordingly, there exists a need in the art for insulating materials that address the improvement of the material properties for the insulating layer. Polymeric materials having higher dielectric constants in combination with lower interfacial or surface energies would enable electrowetting in optical devices with increasingly thinner device architectures. The use of thinner insulating layers would enable the use of lower applied potentials, which can translate into improved liquid lens reliability, performance, and manufacturing cost.

### SUMMARY OF THE DISCLOSURE

According to some embodiments of the present disclosure, an electrowetting optical device is provided. The electrowetting optical device includes a first window, a second window, and a cavity disposed between the first window and the second window. The electrowetting optical device additionally includes a first liquid and a second liquid disposed within the cavity, the first liquid and the second liquid substantially immiscible with each other and having different refractive indices such that an interface between the first liquid and the second liquid defines a variable lens. The electrowetting optical device also includes a common electrode in electrical connection with the first liquid and a driving electrode disposed on a sidewall of the cavity and insulated from the first liquid and the second liquid by an insulating polymer dielectric layer having a glass transition temperature (T_{g}) greater than 85° C. The insulating polymer dielectric layer may be formed using initiated chemical vapor deposition (iCVD).

According to some embodiments of the present disclosure, a method for coating an electrowetting device is provided. The method includes: positioning an electrode substrate disposed on a sidewall of a cavity into an evacuated chamber; directing a gaseous monomer and a gaseous initiator into the evacuated chamber; contacting a surface of the electrode substrate with the gaseous monomer and initiator; and activating the gaseous initiator to polymerize the gaseous monomer and form an insulating polymer dielectric layer in contact with the driving electrode. The insulating polymer dielectric layer is formed by initiated chemical vapor deposition (iCVD).

According to some embodiments of the present disclosure, an electrowetting optical device is provided. The electrowetting optical device includes a first window, a second window, and a cavity disposed between the first window and the second window. The electrowetting optical device additionally includes a first liquid and a second liquid disposed within the cavity, the first liquid and the second liquid substantially immiscible with each other and having different refractive indices such that an interface between the first liquid and the second liquid defines a variable lens. The electrowetting optical device also includes a common electrode in electrical connection with the first liquid and a driving electrode disposed on a sidewall of the cavity and insulated from the first liquid and the second liquid by an insulating polymer dielectric layer having a glass transition temperature (T_{g}) greater than 85° C. The insulating polymer dielectric layer may be formed using initiated chemical vapor deposition (iCVD). The electrowetting optical device exhibits a contact angle hysteresis of no more than 3° upon a sequential application of a driving voltage to the driving electrode from 0V to a maximum driving voltage, followed by a return to 0V.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic cross-sectional view of an exemplary electrowetting optical device according to some embodiments of the present disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The terms “non-miscible” and “immiscible” refer to liquids that do not form a homogeneous mixture when added together or minimally mix when the one liquid is added into the other. In the present description and in the following claims, two liquids are considered non-miscible when their partial miscibility is below 2%, below 1%, below 0.5%, or below 0.2%, all values being measured within a given temperature range, for example at 20° C. The liquids herein have a low mutual miscibility over a broad temperature range including, for example, −30° C. to 85° C. and from −20° C. to 65° C.

In various embodiments, an electrowetting optical device is provided. The electrowetting optical device includes a first window, a second window, and a cavity disposed between the first window and the second window. The electrowetting optical device additionally includes a first liquid and a second liquid disposed within the cavity, the first liquid and the second liquid substantially immiscible with each other and having different refractive indices such that an interface between the first liquid and the second liquid defines a variable lens. The electrowetting optical device also includes a common electrode in electrical connection with the first liquid and a driving electrode disposed on a sidewall of the cavity and insulated from the first liquid and the second liquid by an insulating polymer dielectric layer having a glass transition temperature (T_{g}) greater than 85° C. The insulating polymer dielectric layer may be formed using initiated chemical vapor deposition (iCVD).

Using iCVD to form the insulating polymer dielectric layer on an electrode or other substrate found in an electrowetting optical device enables the ability to form coatings having a combination of desired physical properties including increased dielectric properties, low surface energy, low surface roughness, increased adhesion to substrates, improved chemical resistance, and increased glass transition temperatures that exceed the thermal aging temperatures. The versatility of the iCVD method as disclosed herein enables the formation of insulating polymer dielectric layers with improved material properties as compared to conventional techniques using, for example, regular chemical vapor deposition (CVD) or plasma-enhanced chemical vapor deposition (PEPVD) to form coatings.

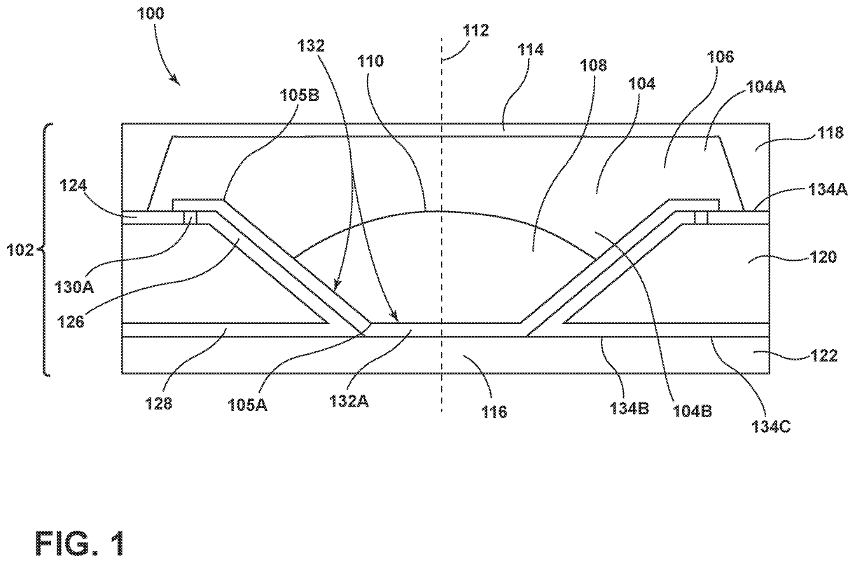

As described in more detail below in FIG. 1, a cell of an electrowetting optical device or liquid lens is generally defined by two transparent insulating plates and side walls. The lower plate, which is non-planar, comprises a conical or cylindrical depression or recess, which contains a non-conductive or insulating liquid. The remainder of the cell is filled with an electrically conductive liquid, non-miscible with the insulating liquid, having a different refractive index and substantially the same density. One or more driving electrodes are positioned on the side wall of the recess. An insulating thin layer may be introduced between the driving electrode(s) and the respective liquids to provide an electrowetting on the dielectric surface having long term chemical stability. A common electrode is in contact with the conductive liquid. Through electrowetting phenomena, it is possible to modify the curvature of the interface between the two liquids, according to the voltage V applied between the electrodes. Thus, a beam of light passing through the cell normal to the plates in the region of the drop will be defocused to a greater or lesser extent according to the voltage applied. The conductive liquid generally is an aqueous liquid containing salts. The non-conductive liquid is typically an oil, an alkane or a mixture of alkanes, possibly halogenated.

In some embodiments, the voltage differential between the voltage at the common electrode and the voltage at the driving electrode can be adjusted. The voltage differential can be controlled and adjusted to move an interface between the liquids (i.e., a meniscus) to a desired position along the sidewalls of the cavity. By moving the interface along sidewalls of the cavity, it is possible to change the focus (e.g., diopters), tilt, astigmatism, and/or higher order aberrations of the liquid lens. Further, during operation of the liquid lens, the dielectric and/or surface energy properties of the liquid lens and its constituents can change. For example, the dielectric properties of the liquids and/or insulating elements can change in response to exposure to the voltage differential over time, changes in temperature, and other factors. As another example, the surface energy of the insulating elements can change in response to exposure to the first and second liquids over time. In turn, the changes in the properties of the liquid lens and those of its constituents (e.g., its insulating elements) can degrade the reliability and performance characteristics of the liquid lens.

### Liquid Lens Structure

Referring now to FIG. 1, a simplified cross-sectional view of an exemplary liquid lens 100 is provided. The structure of the liquid lens 100 is not meant to be limiting and may include any structure known in the art. In some embodiments, the liquid lens 100 may comprise a lens body 102 and a cavity 104 formed in the lens body 102. A first liquid 106 and a second liquid 108 may be disposed within cavity 104. In some embodiments, first liquid 106 may be a polar liquid, also referred to as the conducting liquid. Additionally, or alternatively, second liquid 108 may be a non-polar liquid and/or an insulating liquid, also referred to as the non-conducting liquid. In some embodiments, first liquid 106 and second liquid 108 may be immiscible with each other and have different refractive indices such that an interface 110 between the first liquid and the second liquid forms a lens. In some embodiments, first liquid 106 and second liquid 108 may have substantially the same density, which can help to avoid changes in the shape of interface 110 as a result of changing the physical orientation of liquid lens 100 (e.g., as a result of gravitational forces).

In some embodiments of the liquid lens 100 depicted in FIG. 1, cavity 104 may include a first portion, or headspace, 104A and a second portion, or base portion, 104B. For example, second portion 104B of cavity 104 may be defined by a bore in an intermediate layer of liquid lens 100 as described herein. Additionally, or alternatively, first portion 104A of cavity 104 may be defined by a recess in a first outer layer of liquid lens 100 and/or disposed outside of the bore in the intermediate layer as described herein. In some embodiments, at least a portion of first liquid 106 may be disposed in first portion 104A of cavity 104. Additionally, or alternatively, second liquid 108 may be disposed within second portion 104B of cavity 104. For example, substantially all or a portion of second liquid 108 may be disposed within second portion 104B of cavity 104. In some embodiments, the perimeter of interface 110 (e.g., the edge of the interface in contact with the sidewall of the cavity) may be disposed within second portion 104B of cavity 104.

Interface 110 of the liquid lens 100 (see FIG. 1) can be adjusted via electrowetting. For example, a voltage can be applied between first liquid 106 and a surface of cavity 104 (e.g., one or more driving electrode(s) positioned near the surface of the cavity 104 and insulated from the first liquid 106 as described herein) to increase or decrease the wettability of the surface of the cavity 104 with respect to the first liquid 106 and change the shape of interface 110. In some embodiments, adjusting interface 110 may change the shape of the interface 110, which changes the focal length or focus of liquid lens 100. For example, such a change of focal length can enable liquid lens 100 to perform an autofocus function. Additionally, or alternatively, adjusting interface 110 may tilt the interface relative to an optical axis 112 of liquid lens 100. For example, such tilting can enable liquid lens 100 to perform an optical image stabilization (OIS) function in addition to providing astigmatism variations or higher order optical aberration corrections. Adjusting interface 110 may be achieved without physical movement of liquid lens 100 relative to an image sensor, a fixed lens or lens stack, a housing, or other components of a camera module in which the liquid lens 100 can be incorporated.

In some embodiments, lens body 102 of liquid lens 100 may include a first window 114 and a second window 116. In some of such embodiments, cavity 104 may be disposed between first window 114 and second window 116. In some embodiments, lens body 102 may comprise a plurality of layers that cooperatively form the lens body 102. For example, in the embodiments shown in FIG. 1, lens body 102 may comprise a first outer layer 118, an intermediate layer 120, and a second outer layer 122. In some of such embodiments, intermediate layer 120 may comprise a bore formed therethrough. First outer layer 118 may be bonded to one side (e.g., the object side) of intermediate layer 120. For example, first outer layer 118 may be bonded to intermediate layer 120 at a bond 134A. Bond 134A may be an adhesive bond, a laser bond (e.g., a laser weld), a mechanical closing, or any another suitable bond capable of maintaining first liquid 106 and second liquid 108 within cavity 104. Additionally, or alternatively, second outer layer 122 may be bonded to the other side (e.g., the image side) of intermediate layer 120. For example, second outer layer 122 may be bonded to intermediate layer 120 at a bond 134B and/or a bond 134C, each of which can be configured as described herein with respect to bond 134A. In some embodiments, intermediate layer 120 may be disposed between first outer layer 118 and second outer layer 122, the bore in the intermediate layer may be covered on opposing sides by the first outer layer 118 and the second outer layer 122, and at least a portion of cavity 104 may be defined within the bore. Thus, a portion of first outer layer 118 covering cavity 104 may serve as first window 114, and a portion of second outer layer 122 covering the cavity may serve as second window 116.

In some embodiments, cavity 104 may include first portion 104A and second portion 104B. For example, in the embodiments shown in FIG. 1, second portion 104B of cavity 104 may be defined by the bore in intermediate layer 120, and first portion 104A of the cavity may be disposed between the second portion 104B of the cavity 104 and first window 114. In some embodiments, first outer layer 118 may comprise a recess as shown in FIG. 1, and first portion 104A of cavity 104 may be disposed within the recess in the first outer layer 118. Thus, first portion 104A of cavity 104 may be disposed outside of the bore in intermediate layer 120.

In some embodiments, cavity 104 (e.g., second portion 104B of the cavity 104) may be tapered as shown in FIG. 1 such that a cross-sectional area of the cavity 104 decreases along optical axis 112 in a direction from the object side to the image side. For example, second portion 104B of cavity 104 may comprises a narrow end 105A and a wide end 105B. The terms “narrow” and “wide” are relative terms, meaning the narrow end 105A is narrower than the wide end 105B. Such a tapered cavity can help to maintain alignment of interface 110 between first liquid 106 and second liquid 108 along optical axis 112. In other embodiments, the cavity 104 is tapered such that the cross-sectional area of the cavity 104 increases along the optical axis in the direction from the object side to the image side or non-tapered such that the cross-sectional area of the cavity 104 remains substantially constant along the optical axis.

In some embodiments, image light may enter the liquid lens 100 depicted in FIG. 1 through first window 114, may be refracted at interface 110 between first liquid 106 and second liquid 108, and may exit the liquid lens 100 through second window 116. In some embodiments, first outer layer 118 and/or second outer layer 122 may comprise a sufficient transparency to enable passage of the image light. For example, first outer layer 118 and/or second outer layer 122 may comprise a polymeric, glass, ceramic, or glass-ceramic material. In some embodiments, outer surfaces of first outer layer 118 and/or second outer layer 122 may be substantially planar. Thus, even though liquid lens 100 can function as a lens (e.g., by refracting image light passing through interface 110), outer surfaces of the liquid lens 100 can be flat as opposed to being curved like the outer surfaces of a fixed lens. In other embodiments, outer surfaces of the first outer layer 118 and/or the second outer layer 122 may be curved (e.g., concave or convex). Thus, the liquid lens 100 may comprise an integrated fixed lens. In some embodiments, intermediate layer 120 may comprise a metallic, polymeric, glass, ceramic, or glass-ceramic material. Because image light can pass through the bore in intermediate layer 120, the intermediate layer 120 may or may not be transparent.

In some embodiments, liquid lens 100 (see FIG. 1) may include a common electrode 124 in electrical communication with first liquid 106. Additionally, or alternatively, liquid lens 100 may include one or more driving electrodes 126 disposed on a sidewall of cavity 104 and insulated from first liquid 106 and second liquid 108. Different voltages can be supplied to common electrode 124 and driving electrode(s) 126 to change the shape of interface 110 as described herein.

In some embodiments, liquid lens 100 (see FIG. 1) may include a conductive layer 128 at least a portion of which is disposed within cavity 104. For example, conductive layer 128 may comprise a conductive coating applied to intermediate layer 120 prior to bonding first outer layer 118 and/or second outer layer 122 to the intermediate layer. Conductive layer 128 may include a metallic material, a conductive polymer material, another suitable conductive material, or a combination thereof. Additionally, or alternatively, conductive layer 128 may include a single layer or a plurality of layers, some or all of which can be conductive. In some embodiments, conductive layer 128 may define common electrode 124 and/or driving electrode(s) 126. For example, conductive layer 128 may be applied to substantially the entire outer surface of intermediate layer 118 prior to bonding first outer layer 118 and/or second outer layer 122 to the intermediate layer. Following application of conductive layer 128 to intermediate layer 118, the conductive layer may be segmented into various conductive elements (e.g., common electrode 124 and/or driving electrode 126). In some embodiments, liquid lens 100 may comprise a scribe 130A in conductive layer 128 to isolate (e.g., electrically isolate) common electrode 124 and driving electrode 126 from each other. In some embodiments, scribe 130A may comprise a gap in conductive layer 128. For example, scribe 130A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

As also depicted in FIG. 1, the liquid lens 100 may include an insulating layer 132 disposed within the cavity 104, positioned on top of the driving electrode 126. For example, insulating element 132 may include an insulating coating applied to intermediate layer 120 prior to bonding first outer layer 118 and/or second outer layer 122 to the intermediate layer. In some embodiments, insulating element 132 may include an insulating coating applied to conductive layer 128 and second window 116 after bonding second outer layer 122 to intermediate layer 120 and prior to bonding first outer layer 118 to the intermediate layer. Thus, the insulating element 132 may cover at least a portion of conductive layer 128 within cavity 104 and second window 116. In some embodiments, insulating element 132 may be sufficiently transparent to enable passage of image light through second window 116 as described herein.

In some embodiments of the liquid lens 100 depicted in FIG. 1, the insulating element 132 may cover at least a portion of driving electrode 126 (e.g., the portion of the driving electrode disposed within cavity 104) to insulate first liquid 106 and second liquid 108 from the driving electrode. Additionally, or alternatively, at least a portion of common electrode 124 disposed within cavity 104 may be uncovered by insulating element 132. Thus, common electrode 124 may be in electrical communication with first liquid 106 as described herein. In some embodiments, insulating element 132 may comprise a hydrophobic surface layer of second portion 104B of cavity 104. Such a hydrophobic surface layer can help to maintain second liquid 108 within second portion 104B of cavity 104 (e.g., by attraction between the non-polar second liquid and the hydrophobic material) and/or enable the perimeter of interface 110 to move along the hydrophobic surface layer (e.g., by electrowetting) to change the shape of the interface as described herein. Further, the liquid lens 100 shown in FIG. 1, based at least in part on the insulating element 132, may exhibit a contact angle hysteresis (i.e., at the interface 110 between the liquids 106, 108) of no more than 3°. As used herein, the “contact angle hysteresis” refers to the differential in measured contact angles of the second liquid 108 with the insulating element 132 upon a sequential application of a driving voltage to the driving electrode 126 (e.g., the differential between the driving voltage supplied to the driving electrode and the common voltage supplied to the common electrode) from 0V to a maximum driving voltage, followed by a return to 0V (i.e., as relative to the common electrode 124). The initial contact angle without voltage may be a maximum of 25° and the increase in contact angle due to the electrowetting effect may be at least 15° at “the maximum driving voltage”, as used herein. In other embodiments the driving voltage may provide an AC 1 kHz voltage. In some embodiments, the useful voltage may range from about 25V to about 70V. The choice of driver used to apply the voltage is not meant to be limiting, and the insulating layer 132 thickness may be tuned to fit any driving voltage range delivered by the selected driver.

Referring now to FIG. 1A, embodiments of the liquid lens 100 are configured such that the driving electrode 126 is disposed on a sidewall of the cavity 104 and insulated from the first liquid 106 and the second liquid 108 by the insulating element 132. The insulating element 132 includes an insulating outer layer 132A, as shown, that is in contact with the first and second liquids 106, 108. In some embodiments, insulating outer layer 132A comprises one or more insulating polymer dielectric layers formed using iCVD. Further, in the implementation of liquid lens 100 depicted in FIG. 1A, the insulating element 132 is monolithic in the sense that insulating outer layer 132A (e.g., insulating polymer dielectric layer) serves the dual function of being electrically insulating with regard to the liquids 106, 108 and the driving electrode 126, and hydrophobic with regard to the first liquid 106. The liquid lens 100 depicted in FIG. 1A, given its reliance on one monolithic insulating outer layer 132A, can be advantageous from a processing and/or manufacturing standpoint over other more complex configurations of the insulating element 132 (e.g., those that rely on a plurality of different types of layers).

In embodiments of the liquid lens 100 depicted in FIG. 1A, the thickness of the insulating outer layer 132A of the insulating element 132 is from about 0.5 microns to about 10 microns, from about 1 micron to about 10 microns, from about 1 micron to about 9 microns, from about 1 micron to about 8 microns, from about 1 micron to about 7 microns, from about 1 micron to about 6 microns, from about 1 micron to about 5 microns, from about 1 micron to about 4 microns, from about 1 micron to about 3 microns, from about 1 micron to about 2 microns, and all values between these thickness endpoints. For example, in some embodiments, the thickness of the insulating outer layer 132A of the liquid lens 100 depicted in FIG. 1A is from about 0.5 microns to about 2 microns. In other embodiments, the thickness of the insulating outer layer 132A may range from about 0.5 microns to about 10 microns, 0.5 microns to about 5 microns, from about 0.5 microns to about 2.5 microns, and all values between these thickness endpoints.

Owing to the unexpected combination of hydrophobicity and insulating properties of the insulating outer layer 132A of the insulating element 132, the liquid lenses 100 depicted in FIG. 1 offer several advantages over conventional liquid lens configurations. Among these advantages, it is believed that the insulating polymer dielectric layer of the insulating outer layer 132A provides improved temperature stability for the lenses 100. It is also believed that the insulating polymer dielectric layer of the outer layer 132A provides improved chemical stability (e.g., as compared to polymeric hydrophobic layers) for the lenses, e.g., as judged after a thermal aging treatment. In such a treatment, the liquid lens 100 exhibits a contact angle hysteresis (i.e., at the interface 110 between the liquids 106, 108) of no more than 3° upon a sequential application of a driving voltage to the driving electrode 126 from 0V to the maximum driving voltage, followed by a return to 0V (i.e., as relative to the common electrode 124), wherein the sequential application of the driving voltage is conducted after the insulating layer 132A is subjected to a thermal aging protocol comprising contact with deionized water for one week at 85° C. Still further, it is also believed that the insulating polymer dielectric layer of the outer layer 132A ensures that this layer has electrical characteristics that allow the liquid lens 100 to be employed in a DC-based electrowetting application. In addition, it is also believed that the insulating polymer dielectric layer of the outer layer 132A provides superior scratch and UV resistance as compared to conventional outer polymeric hydrophobic layers of an insulating feature in contact with the liquids, e.g., liquid 106, 108.

### The Insulating Polymer Dielectric Layer

Conventional Materials and their Application Techniques

The chemical environment in which the insulating polymer dielectric layer is used for electrowetting devices may be harsh for many different types of polymer systems since the corresponding polymer layers may be constantly immersed in liquids and, over time, may be susceptible to chemical reactions, leaching, or other changes that can significantly alter their insulating and/or hydrophobicity characteristics. Immersion of these insulating polymer layers in the liquid of the electrowetting device can also lead to swelling and/or plasticization of the polymer. This is particularly true when the lens is subjected to heat at temperatures greater than the glass transition temperature (Tg) of the polymer layer which can prematurely age the insulating polymer layers. Any of these changes may have a negative impact on the reliability of the finished electrowetting device.

Traditional methods used to form polymer layers involve solution-based processes. Solution-based application techniques can create several problematic issues in the final coating formed (e.g., residual chemicals, low durability levels, damage to substrates, and laborious procedures). When a polymer solution is deposited onto a substrate for an electrowetting device, the evaporated solvent and resulting film may be optionally crosslinked further using subsequent processing steps. In addition to the issues addressed above for using solution-based application techniques, liquid coatings formed using this method may also have problems producing a uniform, thin, contiguous film, where the film may exhibit voids due to surface tension effects. Any one or combination of these coating defects may result in device failure either immediately, or over time, resulting in device reliability issues.

Another technique commonly used to fabricate polymeric insulating layers in electrowetting devices includes chemical vapor deposition (CVD), an example of which is the Gorham process used to deposit para-xylylene. Deposition of para-xylylene using CVD has the advantage of forming a uniform conformal coating, but has a drawback that it displays poor adhesion to the underlying substrates. Another well-established chemical vapor coating technique is Plasma-Enhanced Chemical Vapor Deposition (PECVD), in which monomer species are bombarded with plasma ions, ultimately resulting in fragmentation of the monomer which leads to free radical polymerization through a complex series of reactions. The resulting PECVD films are highly cross-linked and mechanically robust; however, the non-selective initiation step damages the properties of the polymer, an example of which is surface roughness.

To help overcome the challenges associated with both processing and the corresponding material properties of these insulating polymer layers mentioned above, the electrowetting optical devices disclosed herein can use initiated chemical vapor deposition (iCVD) to make insulating polymer dielectric layers using solvent-free polymerization methods that enable a plurality of different chain growth polymers that may withstand the environmental conditions present in electrowetting optical devices. The ability to form these insulating polymer dielectric layers using iCVD may also enable surface modifications to the corresponding substrate without changing its bulk properties (e.g., mechanical strength and morphological dimensions).

Initiated Chemical Vapor Deposition (iCVD)

Initiated chemical vapor deposition or iCVD is a polymer deposition process that typically uses traditional free-radical polymerization to form functional chain-growth, addition type polymer films. This iCVD process may introduce initiator and monomeric regents simultaneously into a reactor in the vapor or gaseous phase. The initiators may be thermally decomposed into radical species using a heated filament where the reactive radical species may then be transferred with the monomer molecules through adsorption onto a substrate at moderate temperatures. The thermal initiation of the heated filament may be conducted at a temperature range from about 65° C. to about 300° C., from about 100° C. to about 300° C., from about 150° C. to about 250° C., from about 75° C. to about 150° C., or from about 100° C. to about 200° C. Upon thermal decomposition of the initiator molecules to form radical initiators, the radical initiator species can trigger free radical polymerization of the monomers deposited on the substrate to form a thin polymer film without generating any volatile byproducts. Using the iCVD method, both polymer synthesis and film formation simultaneously occur on the surface of the corresponding substrate. In some embodiments, this one-step iCVD fabrication method requires only the use of monomers and initiator and does not require the use of any solvents and/or additional purification steps.

Solvent-free processing, as outlined using iCVD, can effectively reduce potentially harmful modifications made to the substrate (e.g., delamination, swelling, shrinkage, or wrinkling) that can easily be introduced through the exposure of the substrate to organic solvents. The iCVD is also thermally “gentle” in that iCVD polymerizations proceed at low surface temperatures (e.g., from about 15° C. to about 40° C.) with low energy inputs, rendering the coating process compatible with a broad range of thermally vulnerable substrates (e.g., paper, fabrics and membranes). In some embodiments, the gaseous monomer and gaseous initiator may contact and polymerize on the substrate at a temperature from about 15° C. to about 40° C.

In some embodiments, the surface temperature of the iCVD process may be determined as the temperature at which dilute gaseous monomers are concentrated into a cool substrate to increase the deposition rate to as high as a few hundreds of nm/min while maintaining a smooth polymer surface by balancing the reaction rate with the adsorption rate of gaseous monomers.

The iCVD process is able to be performed at low operating pressures, typically in the 10-100 Pa (75-750 mTorr) range, allow conformal coating of extremely fine objects such as particles. The term “Conformal”, as used herein, is defined to mean that that the features of the object being coated, such as angles, scale, etc. are generally preserved. Besides the thermal degradation of the initiator species using the relatively low filament temperatures, no electrical excitation of the gas is required and insulating polymer dielectric layer growth proceeds via conventional polymerization pathways. Deposition rates of greater than 10 nm/minute, greater than 25 nm/minute, greater than 50 nm/minute, greater than 75 nm/minute, greater than 100 nm/minute, or greater than 150 nm/minute may be obtained using this iCVD technique.

In the iCVD process, the substrates being coated typically remain at or near room temperature. In contrast, wet spray-on versions of hydrophobic fluoropolymers, such as DuPont's PTFE-based Teflon® containing pre-polymerized PTFE particles, have to be sintered together at >315° C. before use. In some embodiments, the substrate to be coated is heated to a temperature above room temperature, such as 35° C., 50° C., 75° C., 100° C., or 150° C. In other embodiments, the substrate is maintained at a temperature less than room temperature, such as 20° C., 15° C., 10° C., 5° C., 0° C., −5° C., −10° C., or −25° C. In still other embodiments, the substrate to be coated may be maintained at approximately room temperature, from about 20° C. to about 75° C., from about 25° C. to about 60° C., from about 20° C. to about 35° C., or from about 25° C. to about 30° C.

Wet-applied fluorinated hydrophobic coatings may contain harmful surfactants and can be difficult to deposit uniformly. Unlike conventional wet-applied coatings, coatings deposited using iCVD are immediately ready to use after deposition, contain no surfactants, and require no post-processing (i.e., no high temperature drying or annealing). However, post-processing steps to modify surface morphology or surface chemistry can be applied for any desired application.

Conventional coating processes like solution coating, CVD, and/or PECVD apply coatings one layer at a time. For example, when parylene is typically used in coating applications, it is common to add an additional and separate hydrophobic top coat to the parylene layers requiring multiple process steps. The use of iCVD as a deposition tool enables the application of a gradient or layered coating in just one step. In some embodiments, the iCVD process may apply the insulated polymer dielectric layer as a single layer, a gradient layer, and/or a plurality of layers. In some embodiments, the iCVD process may apply the insulated polymer dielectric layer as a gradient coating. For example, in some embodiments, the insulated polymer dielectric layer may include a first layer where a majority or first portion of the first layer is highly cross-linked and includes a high Tg polymer or co-polymer (e.g., greater than 85° C.) that can provide chemical resistance to the fluids of the electrowetting device. In some embodiments, the first layer many be capped or graded with a second layer that may include a low surface energy polymer (e.g., heptadecafluorodecyl (meth)acrylate; octafluoropentyl acrylate). In some embodiments, the iCVD process can enable building a gradient insulated polymer dielectric layer in one chamber by manipulated the desired monomer flow during the deposition process.

iCVD Precursor Materials

### 1. Substrates

In some embodiments, the substrate coated using iCVD in the electrowetting optical device is the conductive layer 128 (see FIG. 1). The conductive layer 128 may include a metallic material, a conductive polymer material, another suitable conductive material, or a combination thereof. Additionally, or alternatively, the conductive layer 128 may include a single layer or a plurality of layers, some or all of which can be conductive. In some embodiments, the conductive layer 128 may define the common electrode 124 and/or the driving electrode 126 (see FIG. 1). For example, conductive layer 128 may be applied to substantially the entire outer surface of intermediate layer 118 prior to bonding first outer layer 118 and/or second outer layer 122 to the intermediate layer 118 (see FIG. 1). In some embodiments, the iCVD-deposited polymers coupled to the conductive layer 128 may be highly conformal to the conductive layer 128 substrates. In some embodiments, the reaction conditions used in the iCVD process may use low initiation temperatures (e.g., from about 75° C. to about 150° C.) on low temperature substrates (e.g., from about 20° C. to about 35° C.) allowing for them to remain at or near room temperature and avoiding damage due to energetic attack on the substrate common to methods such as plasma CVD.

Additional types of materials that may be used as substrates include, but are not limited to, metals, metal oxides, ceramics, glasses, fibrous substrates, and other traditional device substrate materials such as silicon. In some embodiments, the substrate may be a plastic including, but are not limited to, thermoplastics, thermosets, and biopolymers (e.g., polyethylene (PE), polypropylene (PP), polyethylene terephthalate (PET), polydimethylsiloxane (PDMS), polystyrene (PS), polycarbonates (PC), polytetrafluoroethylene (PTFE), and others).

In some embodiments, the substrate may be treated prior to the iCVD process to improve adhesion. For example, in some embodiments, the surface morphology of the substrate may be exposed to electron beam, IR radiation, gamma radiation, plasma exposure, thermal treatment, and/or laser exposure to roughen the surface of the substrate to improve adhesion. In some embodiments, the insulating polymer dielectric layer may be covalently grafted to the driving electrode 126 or the conductive layer 128 (see FIG. 1)

### 2. Monomers

Exemplary vinyl monomers that may be used with the iCVD process, either alone or in any combination with each other, are represented by Formulas I-XII below:

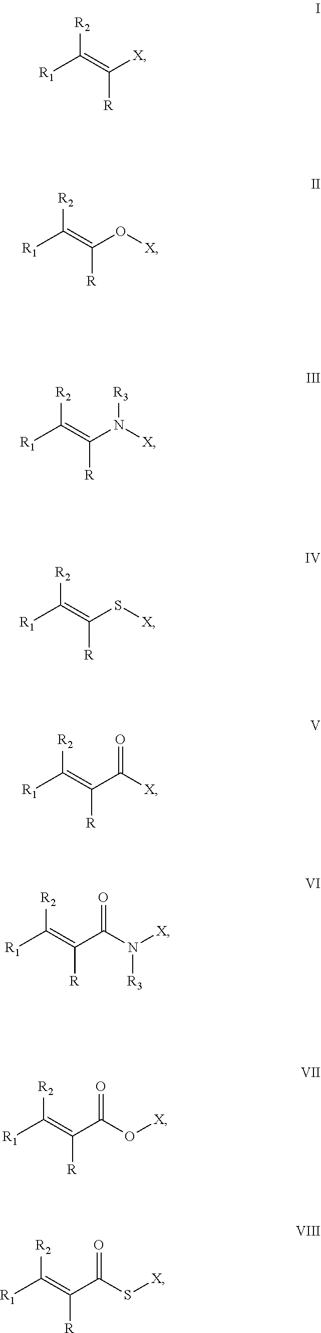

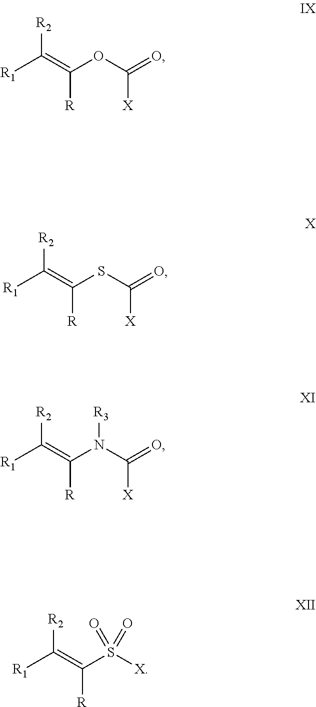

wherein R, R₁, R₂, and R₃ are each independently selected from hydrogen, alkyl, fluoroalkyl, aralkyl, alkenyl, heteroaralkyl, and carboxyl; halogen (e.g., bromine, chlorine, fluorine, etc.), hydroxyl, alkyoxy, aryloxy, carboxyl, amino, acylamino, amido, carbamoyl, sulfhydryl, sulfonate, and sulfoxido; X comprises hydrogen, alkyl, cycloalkyl, heteocycloalkyl, aryl, heteroaryl, aralkyl, heteoaralkyl, and —(CH₂)ₙY, where Y is selected from the group consisting of hydrogen, alkyl, cycloalkyl, heterocycloalkyl, aryl, heteroaryl, aralkyl, heteoaralkyl, nitro, halo, hydroxyl, alkyoxy, aryloxy, carboxyl, heteroaryloxy, amino, acylamino, amido, carbamoyl, sulfhydryl, sulfonate, and sulfoxido; and n is 1-10 inclusive.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, halo alkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bomyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbomyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

In some embodiments, R, R₁, R₂, R₃, and X may each independently be selected from substituent groups including hydrogen; halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and combinations thereof.

In some embodiments, the iCVD process may be used to polymerize fluorinated monomers containing vinyl bonds. The solubility of fluoropolymers is typically very limited and require the use of corrosive solvents for liquid-base film casting process. The vapor-free technique used in iCVD process avoids the difficulties resulting from surface tension and nonwetting effects, allowing ultrathin films (<10 nm) to be applied to virtually any substrate. In some embodiments, iCVD technique may be used to apply the insulating polymer dielectric layers from fluoropolymers including, but not limited to, polytetrafluoroethylene, poly(ethylene-co-tetrafluoroethylene), fluorinated ethylene propylene, perfluoroalkoxy alkanes, 1H,1H,2H,2H-perfluorodecylacrylate, or copolymers of terafluoroethylene and 2,2-bis(trifluoromethyl)-4,5-difluoro-1,3-dioxole. In some embodiments, the insulating polymer dielectric layer includes an amorphous fluoropolymer. In other embodiments, the insulating polymer dielectric layer includes a polytetrafluoroethylene.

In some embodiments, the iCVD process may be used to polymerize polysiloxane (“silicone”) coatings formed from siloxane-containing monomers including, but not limited to, vinyl siloxane monomers. In some embodiments, the dense network of siloxane functionality may make the corresponding coating layer more resistant to swelling and dissolution compared with coatings having little or no crosslinking. In other embodiments, the iCVD applied polymer may include both fluorine and siloxane moieties.

In some embodiments, the monomers used in the iCVD process may include acrylate crosslinkers. In some embodiments, the monomers used in the iCVD process may include heptadecafluorodecyl (meth)acrylate; octafluoropentyl acrylate; poly(divinylbenzene); cyclotrisiloxane-2,4,6-trimethyl-2,4,6-trivinyl; 2,4,6,8-tetramethyl-2,4,6,8-tetravinylcyclotetrasiloxane; hexavinyldisiloxane; or a combination thereof.

In some embodiments, iCVD copolymers may include one or more fluorinated monomers with one or more vinyl monomers that may be used to tune surface energy, surface roughness, degree of crystallinity, thermal stability, and mechanical properties. Such control over surface properties at the interface of the electrowetting device and the respective fluids can be important in electrowetting applications, since the surface energy and roughness can directly determine the contact angles achieved with liquids and the corresponding hysteresis between the advancing and receding angles. In some embodiments, reducing the crystallinity using the appropriate ratios of monomers in a copolymerization can reduces the probability of the formation of pinholes resulting from the incomplete surface coverage that occurs when two or more crystallite domains meet. In some embodiments, films containing no pin-holes may be required for some applications using the insulating polymer dielectric layer. In some embodiments, thermal, e-beam, or UV post-treatments can alter the surface properties of the iCVD polymer layer, what many lead to changes in the observed contact angles and hysteresis behavior.

### 3. Initiators

Exemplary free radical initiators that may be used with the iCVD process, either alone or in any combination with each other, may include halogens, azo compounds (e.g., azobisisobutyronitrile and 1,1′-azobis(cyclohexanecarbonitrile)), organic peroxides (e.g., di-tert-butyl peroxide and benzoyl peroxide), inorganic peroxide (e.g., peroxydisulfate), and any other organic, inorganic, or transition metal catalyst known in the art to produce radical initiators.

Material Properties of the Insulating Polymer Dielectric Layer

In an optical electrowetting device, such as for example optical liquid lenses controlled by electrowetting, the insulating polymer dielectric layer may be in contact with the second fluid and with the first fluid. In some embodiments, the dielectric properties (e.g., dielectric constant, breakdown voltage, dissipation factor) of the insulating dielectric layer may be retained over time when in contact with the first and second fluids over a broad temperature range including, for example, from about ˜40° C. to about 85° C. In some embodiments, the insulating polymer dielectric layer may not present any chemical interactions with the first and second fluids present in the electrowetting optical device.

In some embodiments, the insulating polymer dielectric layer of the optical electrowetting device is made of a polymer material presenting one or more of the following features:
the insulating polymer material is an electrically insulating dielectric material;
the insulating polymer material is hydrophobic and/or of low polarity, for example a polarity comprised between about 0 mN/m and about 4 mN/m;
the insulating material is a polymer having a low relative dielectric constant ∈r, preferably lower than about 3.5 at 1 kHz when used as a wettable surface;
the insulating polymer material has a high breakdown voltage, e.g., greater than about 1 MV/cm, greater than about 2 MV/cm, greater than about 3 MV/cm, or greater than about 4 MV/cm, to enable the minimization of short circuit risks and increase the dielectric life time;
the insulating polymer material has a low dissipation factor D, typically lower than about 0.05, lower than about 0.03, or lower than about 0.01;
the polymer material has a high reliability (i.e. is not damaged) over a wide period of time and on a wide temperature range, especially between about −50° C. to about +125° C., between about −40° C. to about +110° C., or between about −40° C. to about +85° C.;
the insulating polymer material has no or limited physical/chemical interaction with the second liquid (e.g. conductive) and the first liquid (e.g., non-conductive fluids), i.so the insulating polymer material is highly resistant to most chemicals;
the insulating polymer material has no or limited water absorption, typically less than about 0.3% per 24 hr or less than about 0.1% per 24 hr;
the insulating polymer material is not soluble in the conductive and non-conductive fluid between −40° C. and +85° C.;
the insulating polymer material has high transparency (transmission >90% in visible wavelength) and/or low optical dispersion;
the insulating polymer material has a good adhesion on the conductive layer 128 *see FIG. 1) as measured by adhesion test ASTM D3359-02, in order to help prevent from spontaneous delamination of the insulating polymer layer in the presence of the fluids;
the insulating polymer material has a low UV and visible absorption to limit temperature rise during light irradiation of the device and to prevent/avoid from chemical reactions between with the insulating substrate and the fluids in contact;
the insulating polymer material may be characterized by a surface roughness indicative of the initiated chemical vapor deposition (iCVD) process having features with an average maximum height of less than 200 nm, less than 100 nm, less than 50 nm, less than 25 nm, less than 20 nm, less than 10 nm, less than 5 nm, less 2 nm, or less than 1 nm;
the insulating polymer material has a high melting temperature and a high glass transition temperature above 85° C.

In some embodiments, the insulating polymer dielectric layer may have a glass transition temperature greater than about 85° C., greater than about 95° C., greater than about 105° C., greater than about 115° C., or greater than about 125° C. In some embodiments, the elevated glass transition temperature of the insulating polymer dielectric layer may help increase both the chemical and physical stability of the insulating polymer dielectric layer when exposed to the first liquid and the second liquid utilized in the electrowetting optical device.

In some embodiments, the porosity of the insulating polymer dielectric layer formed using the iCVD method may be controlled. For example, in some embodiments, the size and density of the polymer film's porosity may be controlled by manipulating the pyrolytic CVD conditions (such as pressure, filament temperature, substrate temperature, monomer to initiator ratio, and residence time) of the iCVD method. In other embodiments, the selection of monomer or monomers and optionally free radical initiator may help control the porosity.

In the embodiments disclosed herein, the iCVD polymerization technique has proven to be extremely versatile. In some embodiments, the iCVD does not require the use of a solvent and the iCVD initiation step does not result in degradation of the monomers and is decoupled from the site of film growth. Consequently, surface tension and de-wetting effects may be absent while the resultant insulating polymer layers uniformly coat the geometry of the underlying substrate. In other embodiments, an additional advantage of these iCVD prepared polymer films can be a more uniform coating over high-aspect ratio features, as there is no competition between film growth (deposition) and damage (etching). Lastly, in some embodiments, the iCVD prepared polymer films can exhibit very low surface roughness.

According to some embodiments, the electrowetting optical device includes a voltage source for applying an A.C. voltage to vary the meniscus formed between the conductive and non-conductive liquids to control the focal length of the lens. In some embodiments, the electrowetting optical device further includes a driver or similar electronic device for controlling the lens where the lens and driver or similar electronic device are integrated into the liquid lens. In other embodiments, the electrowetting optical device may include a plurality of lenses incorporating at least one driver or similar electronic device.

The electrowetting optical device may be used as or be part of a variable focal length liquid lens, an optical zoom, an ophthalmic device, a device having a variable tilt of the optical axis, an image stabilization device, a light beam deflection device, a variable illumination device, and any other optical device using electrowetting. In some embodiments, the liquid lens/electrowetting optical device may be incorporated or installed in any one or more apparatuses including, for example, a camera lens, a cell phone display, an endoscope, a telemeter, a dental camera, a barcode reader, a beam deflector, and/or a microscope.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. (canceled)

2. The electrowetting optical device according to claim 17, wherein the insulating polymer dielectric layer comprises an amorphous fluoropolymer.

3. (canceled)

4. The electrowetting optical device according to claim 17, wherein the insulating polymer dielectric layer is covalently grafted to the driving electrode.

5. The electrowetting optical device according to claim 17, wherein the insulating polymer dielectric layer comprises poly(ethylene-co-tetrafluoroethylene), fluorinated ethylene propylene, perfluoroalkoxy alkanes, 1H,1H,2H,2H-perfluorodecylacrylate, or copolymers of terafluoroethylene and 2,2-bis(trifluoromethyl)-4,5-difluoro-1,3-dioxole.

6. (canceled)

7. The electrowetting optical device according to claim 17, wherein the insulating polymer dielectric layer has a thickness from about 0.5 microns to about 2.5 microns.

8. (canceled)

9. A method for coating an electrowetting device, the method comprising:
positioning an electrode substrate disposed on a sidewall of a cavity into an evacuated chamber;
directing a gaseous monomer and a gaseous initiator into the evacuated chamber;
contacting a surface of the electrode substrate with the gaseous monomer and initiator; and
activating the gaseous initiator to polymerize the gaseous monomer and form an insulating polymer dielectric layer in contact with the driving electrode;
wherein the insulating polymer dielectric layer is formed by initiated chemical vapor deposition (iCVD) and is characterized by a surface roughness indicative of the iCVD process having features with an average maximum height of less than 200 nm.

10. The method according to claim 9, further comprising:
treating the electrode substrate prior to positioning in the evacuated chamber, wherein the treatment comprises roughening, polishing, electron beam, IR radiation, gamma radiation, plasma exposure, thermal treatment, laser exposure, or a combination thereof.

11. The method according to claim 9, wherein the monomer comprises a difluorocarbene, ethylenedioxythiophene, trivinyltrimethylcyclotrisiloxane, hydroxyethylmethacrylate, vinylpyrrolidone, vinyl monomers, functional acrylates, functional methacrylates, diacrylates, dimethacrylates, and vinyl siloxanes.

12. The method according to claim 9, wherein the contacting step is performed at a temperature from about 14° C. to about 40° C.

13. The method according to claim 9, wherein the activating step is performed at a temperature from about 75° C. to about 150° C.

14. The method according to claim 9, wherein the insulating polymer dielectric layer comprises poly(ethylene-co-tetrafluoroethylene), fluorinated ethylene propylene, perfluoroalkoxy alkanes, 1H,1H,2H,2H-perfluorodecylacrylate, or copolymers of terafluoroethylene and 2,2-bis(trifluoromethyl)-4,5-difluoro-1,3-dioxole.

15. The method according to claim 9, wherein the insulating polymer dielectric layer has a thickness from about 0.5 microns to about 10 microns.

16. (canceled)

17. An electrowetting optical device comprising:
a first window, a second window, and a cavity disposed between the first window and the second window;
a first liquid and a second liquid disposed within the cavity, the first liquid and the second liquid having different refractive indices such that an interface between the first liquid and the second liquid defines a variable lens;
a common electrode in electrical connection with the first liquid;
a driving electrode disposed on a sidewall of the cavity and insulated from the first liquid and the second liquid by an insulating polymer dielectric layer having a glass transition temperature (T_{g}) greater than 85° C.,
wherein the insulating polymer dielectric layer is formed on the driving electrode by initiated chemical vapor deposition (iCVD), and
wherein the device exhibits a contact angle hysteresis of no more than 3° upon a sequential application of a driving voltage to the driving electrode from 0V to a maximum driving voltage, followed by a return to 0V.

18. The electrowetting optical device according to claim 17, wherein the insulating polymer dielectric layer comprises a polytetrafluoroethylene.

19. The electrowetting optical device according to claim 17, wherein the insulating polymer dielectric layer has a thickness from about 0.5 microns to about 10 microns.

20. The electrowetting optical device according to claim 17, wherein the insulating polymer dielectric layer is characterized by a surface roughness indicative of the iCVD process having features with an average maximum height of less than 200 nm.
